(19) United States
(12) Patent Application Publication
(10) Pub. No.: US 2008/0233820 A1
(43) Pub. Date: Sep. 25, 2008

(54) Method of treating burlap

(76) Inventor: Michael P. Pompeo, Sumter, SC (US)

Correspondence Address: HAYDEN STONE, PLLC, 101 NORTH COLUMBUS ST., SUITE 409, ALEXANDRIA, VA, 22301, US

(21) Appl. No.: 12/076,704

(22) Filed: Mar. 21, 2008

Related U.S. Application Data
(60) Provisional application No. 60/907,172, filed on Mar. 23, 2007.

(51) Int. Cl. B05D 3/02; B32B 9/04

(52) U.S. Cl. 442/153; 427/372.2

(57) ABSTRACT

A method for treating fabrics or mats made from sisal, jute, or coir includes the steps of contacting the fabrics or mats with an aqueous suspension of sub-micron particles of a sparingly soluble salt of copper, sparingly soluble salt of zinc, or both so that the sub-micron particles impregnate or adhere onto the fabrics or mats.

### FIELD OF THE INVENTION

The present invention is directed to a method of preserving rough fabrics, in particular burlap, using sub-micron particulate copper salts.

### BACKGROUND OF THE INVENTION

The use of selected copper compounds to treat burlap is known. Common use of burlap is to wrap root balls on transplanted trees and bushes, or to form a sand bag. Untreated burlap (sisal or woven hemp fiber from India) will rot within two weeks if moist or in contact with soil. However, there is a possibility that untreated burlap will rot and lose structural integrity before the re-planting of the transplanted tree or bush. While untreated burlap can be left on a root ball and will disintegrate in the ground as the transplanted plant grows, treated burlap generally should be removed from root ball during planting.

An early example of copper compounds used to preserve burlap can be found in “The Use of Copper Naphthenate Treated Burlap in Forest Nursery Operations” by D. A. Anderson and G. U. Kinneer (Journal of Forestry, Volume 47, Number 6, 1 Jun. 1949, pp. 470-473(4), Society of American Foresters). Another compound is zinc naphthenate. Solvent-borne copper naphthenate was used for many years to treat burlap although it has serious explosivity/fire and odor concerns, and are environmentally undesirable.

Some burlap sacking is treated with copper sulfate to prevent rot. Treating with copper sulfate gives the burlap a blue or green color. Copper sulfate is a very water-soluble treatment which will quickly be washed from burlap. Copper sulfate solutions combined with a resin had been used until the EPA forced treaters to stop the practice.

A commercially available product contains 15% copper 8-quinolinolate (“Copper-8-quinolate”) controls rot-producing fungi but is not cost competitive.

U.S. Pat. No. 6,572,788 describes the use of amine oxides as wood preservatives which exhibits low toxicity, high stability in water, low corrosivity to metal substrates (such as steel substrates), excellent penetration and uniform distribution into wood, low odor, waterproofing properties, and high leaching resistance. The wood preservative composition may be applied to fiber materials such as cotton, burlap, and like materials. U.S. Pat. No. 5,424,324 describes the use of bonded fabrics such as burlap or canvas treated with isothiazolones. These treatments are prohibitively expensive and the treated fibers will not rot away even over extended periods of time. U.S. Pat. No. 3,524,761 describes the use of a soluble zinc ammonia borate complex on fabrics. The ammonia would be expected to vaporize, leaving zinc borate, which is a preservative and is important in fire retardation. Zinc borate formed by such a process would be rapidly leached from the fabric. Further, ammonia emissions and odor are significant issues.

The predominate treatment for burlap is by immersing burlap into an aqueous copper ammonium carbonate solution (having 2.5% to 8% by weight Cu and 2.5% to 8% by weight NH₃). The burlap fabric is stitched together into a long roll, passed through a dip trough containing diluted copper ammonium carbonate solution and then over multiple steam-jacketed rollers held at 250° F. The fugitive vapors are vented outdoors or are treated. The final copper carbonate concentration in the “dried” burlap is targeted at just over 1.0% with 20-25% residual moisture left in to facilitate handling. However, the copper compounds are quickly leached from the burlap by water. Further, ammonia emissions and odor are significant issues, and treaters anticipate that ammonia emissions will eventually be regulated. While some treaters are installing a scrubber to handle the large amounts of aqua ammonia (or ammonium sulfate if they scrub with sulfuric acid), this is a significant added expense.

### SUMMARY OF THE INVENTION

It is an object of this invention to provide an inexpensive preservative treatment composition and method of treating burlap and similar fabrics. It is another object of this invention to provide a preservative treatment for burlap and similar fabrics that is more resistant to leaching of the active ingredient by water than is the burlap treated by for example copper sulfate, ammonium copper carbonate, or ammonium copper borate, but is less resistant to leaching of the active ingredient by water than is burlap treated by solvent-borne copper naphthanate. It is another object of this invention to provide a method of treating burlap and similar fibers to provide a preservative treatment without any substantial amount of ammonia or similar volatile amines (e.g., ethanolamines) and without any substantial amount of organic solvents. It is another object of this invention to provide a method of treating burlap and similar fibers to provide a copper-based preservative treatment without any substantial amount of ammonia or similar volatile amines (e.g., ethanolamines) and without any substantial amount of organic solvents. It is another object of this invention to provide a method of treating burlap and similar fibers to provide a zinc-based preservative treatment without any substantial amount of ammonia or similar volatile amines (e.g., ethanolamines) and without any substantial amount of organic solvents. The phrase “without any substantial amount of ammonia or similar amines” should be construed to mean that the composition contacting the burlap or similar fabric to apply the preservative contains less than 1 mole, preferably less than 0.5 moles, more preferably less than 0.1 moles of ammonia or similar volatile amines per mole of copper, zinc, or both in the treatment composition. The phrase “without any substantial amount of organic solvents” should be construed to mean that the composition contacting the burlap or similar fabric to apply the preservative contains less than 1%, preferably less than 0.1%, and more preferably less than 0.01% by weight of organic solvents. The most preferred treatment compositions of this invention have no ammonia or similar volatile amines and no organic solvents.

Common natural fibers for matting include sisal (often used in wall coverings), jute (used to make rope and burlap bags), and coir (from coconut husks). While our focus is predominately on burlap, it is readily apparent that the compositions and methods described here are useful with sisal, jute, and coir in any product, be it fabric or for example a mat.

The invention is a method of applying a preservative onto burlap and similar fabrics, and the resulting burlap or similar fabrics having preservative thereon, the method comprising: 1) contacting the burlap or similar fabrics with a composition comprising water and sub-micron particles of a sparingly soluble salt of copper, zinc, or both so that particles of a sparingly soluble salt of copper, zinc, or both impregnate or adhere onto the burlap or similar fabric; and 2) at least partially drying the treated burlap or similar fabric. A preferred approach to preserving burlap is by treating the burlap with an aqueous-based suspension of inorganic copper salt particles. The size of these particles is small enough such that they easily become embedded in the pores of the fabric and thus remain adhered, even after drying and handling. Particulates applicable to this invention include, but are not limited to basic copper carbonate, copper hydroxide and zinc borate.

### Description of the Prefered Embodiments

By “sparingly soluble” we mean the salt has a Kₛₚ in pure water between about 10⁻⁸ to about 10⁻²⁴ for salts with only one anion, and from about 10⁻¹² to about 10⁻²⁷ for salts with two anions. Preferred sparingly soluble salts have a Kₛₚ between about 10⁻¹⁰ to about 10⁻²¹. As used herein, preferred sparingly soluble inorganic salts includes salts with a Kₛₚ of between about 10⁻¹² to about 10⁻²⁴ for salts with only one anion, and from about 10⁻¹⁴ to about 10⁻²⁷ for salts with two anions.

Preferred sparingly soluble copper salts include copper hydroxide, basic copper carbonate, basic copper chloride (copper oxychloride), and basic copper sulfate. The copper-containing particulates can comprise or consist essentially of any sparingly soluble copper salts, including those selected from copper hydroxides; copper carbonates (e.g., “yellow” copper carbonate); basic (or “alkaline”) copper carbonate; basic copper phosphate, basic copper phosphosulfate, basic copper sulfates including particularly tribasic copper sulfate; basic copper nitrates; copper oxychlorides (basic copper chlorides); copper borates; basic copper borates; and mixtures and combinations thereof. In one embodiment the sparingly soluble copper salts in the copper-containing biocidal particles comprise or consist essentially of one or more copper salts selected from copper hydroxides; copper carbonates, basic copper carbonate; basic copper phosphate, basic copper phosphosulfate, tribasic copper sulfate; copper oxychlorides (basic copper chlorides); basic copper borates, and mixtures thereof. Preferably the sparingly soluble copper salts in the copper-containing biocidal particles comprise or consist essentially of one or more copper salts selected from copper hydroxide; basic copper carbonate; tribasic copper sulfate; copper oxychlorides (basic copper chlorides); and mixtures thereof. The more preferred inorganic copper salts are copper hydroxide and basic copper carbonate. Basic copper carbonate is most preferred. In one embodiment, the particles comprise at least about 20%, 30%, 50%, or 75% by weight of the any of these sparingly soluble copper salts. Advantageously the sparingly soluble salts are crystalline. Preferably the particles comprise at least about 50%, for example at least 75%, by weight of the any of these sparingly soluble copper salts. The remainder may be dispersants and the like. Proper selection of dispersants can increase particle tenacity on the treated fabris.

In another embodiment the particles comprise or consist essentially of sparingly soluble zinc salts include zinc hydroxide, zinc carbonate, and zinc borate. In one embodiment, the particles comprise at least about 20%, 30%, 50%, or 75% by weight of the any of these sparingly soluble zinc salts. Preferably the particles comprise at least about 50%, for example at least 75%, by weight of the any of these sparingly soluble zinc salts.

By sub-micron particles we mean: 1) the d₉₅ is about 1.5 microns or less, meaning 95% of the total weight of the particles has a size (average diameter) of less about 1.5 microns; and 2) the d₅₀ is between 0.08 microns and 0.8 microns, meaning 50% of the total weight of the particles has a size (average diameter) of less than 0.8 microns but greater than 0.08 microns. Preferably, the d₉₅ is about 1 microns or less, more preferably 0.8 microns or less, meaning 95% of the total weight of the particles has a size (average diameter) of less about 1 micron, preferably less than 0.8 microns; and 2) the d₅₀ is between 0.1 microns and 0.4 microns, meaning 50% of the total weight of the particles has a size (average diameter) of less than 0.4 microns but greater than 0.1 microns.

We believe drying aqueous ammonia-copper compositions (both carbonate and borate) provide particles in the range of 0.05 microns. Larger particles are less leachable than these 0.05 micron particles. Preferably, the copper-containing biocidal particles are sufficiently insoluble so as to not be quickly removed by leaching but are sufficiently soluble to exhibit toxicity to primary organisms primarily responsible for the decay of the burlap and to be leached from the burlap after a few months of normal intermittent contact with water.

If the preservative comprises or consists essentially of sparingly soluble copper salts, then advantageously the burlap or similar fabrics are treated to provide between 0.3% and 2.5% by weight of copper (as metallic copper) based on the weight of the treated dried burlap, more preferably to provide between 0.6% and 1.6% by weight of copper (as metallic copper) based on the weight of the treated dried burlap, most preferably to provide between 0.8% and 1.4% by weight of copper (as metallic copper) based on the weight of the treated dried burlap. Advantageously the treated burlap had a very light green or blue color indicative of treatment. Advantageously no visible residue remains on the surface or is observed to be sloughed off upon handling.

If the preservative comprises or consists essentially of sparingly soluble zinc salts, then advantageously the burlap or similar fabrics are treated to provide between 0.3% and 2.5% by weight of copper and zinc (as metallic copper/zinc) based on the weight of the treated dried burlap, more preferably to provide between 0.6% and 1.6% by weight of copper and zinc (as metallic copper/zinc) based on the weight of the treated dried burlap, most preferably to provide between 0.8% and 1.4% by weight of copper and zinc (as metallic copper/zinc) based on the weight of the treated dried burlap. Advantageously the treated burlap had a very light green or blue color indicative of treatment. Advantageously no visible residue remains on the surface or is observed to be sloughed off upon handling.

### EXAMPLES

A suspension of basic copper carbonate particles having 2.5% by weight metal copper content was prepared by dispersing 1 part of a concentrated (25% metallic copper) micronized basic copper carbonate suspension in 10 parts tap water. The median particle size (d₅₀) of the particulates in this suspension was 0.2 to 0.4 microns (200 nm-400 nm) with a range of 0.05 to 0.8 microns (50 nm up to 800 nm). The basic copper carbonate suspension included sufficient dispersants to keep the particles suspended with only occasional mixing. A 4″ by 8″ piece of burlap was immersed in the suspension for 30 seconds, blotted to remove excess liquid and then dried in an electric laboratory oven at 105° C. (221° F.) overnight. A 2″ wide section of the dried burlap sample was extracted for 5 minutes in concentrated acetic acid and the resulting solution analyzed by iodometric titration. A copper loading of 1.46% was observed, well over the target for treating with copper ammonium carbonate solutions. The burlap had a very light green color, indiciative of treatment. No visible residue remained on the surface or sloughed off upon handling.

In order to obtain a loading closer to the 1% by weight of copper (as metallic copper) target a 1.8% metal copper suspension was prepared as above and used to treat burlap by the same procedure. Titration revealed that a 1.04% copper metal loading was achieved. Similarly a 1.5% metal copper suspension resulted in a 0.93% copper loading. It can be seen that the loading of preservative on the fabric is readily varied by changing the concentration of suspended particles in the treating suspension.

A suspension of copper hydroxide particles having a 2.5% metallic copper content was prepared by dispersing 1 part of commercially available Champ DP® (37.5% Cu, available from Phibro-Tech Inc, Sumter, S.C.) in 15 parts tap water. The d₈₀ of these particles was 200 nm, and the d₅₀ of these particles was between 100 and 170 nm. Treatment as above yielded a light blue colored burlap, indicating the copper hydroxide impregnated and adhered to the burlap.

An aqueous suspension of zinc borate particles having a 2.0% zinc borate concentration was prepared by dispersing 1 part of a concentrated (30%) micronized Borogard ZB® zinc borate suspension in 15 parts tap water. The median particle size was 200-400 nm. Treatment as above caused little visible color change of the burlap. No further analysis was conducted.

A stability study was initiated on swatches of treated burlap. Samples are being stored in contact with moist soil at 50-60 F.

What is claimed:

1. A method for treating fabrics or mats made from sisal, jute, or coir comprising the steps of:
A) contacting the fabrics or mats with an aqueous suspension comprising water and sub-micron particles of a sparingly soluble salt of copper, sparingly soluble salt of zinc, or both so that the sub-micron particles of a sparingly soluble salt of copper, sparingly soluble salt of zinc, or both impregnate or adhere onto the fabrics or mats; and
B) drying the treated fabrics or mats, wherein the copper and zinc content of the treated fabrics or mats is between 0.3% and 2.5% by weight of copper and zinc (as metallic copper and zinc) based on the weight of the treated dried fabrics or mats.

2. The method of claim 1 wherein the fabric is burlap.

3. The method of claim 1 wherein the particles comprise a sparingly soluble salt of copper.

4. The method of claim 3 wherein copper content of the treated fabrics or mats is between 0.6% and 1.6% by weight of copper (as metallic copper) based on the weight of the treated dried fabrics or mats.

5. The method of claim 3 wherein copper content of the treated fabrics or mats is between 0.8% and 1.4% by weight of copper (as metallic copper) based on the weight of the treated dried fabrics or mats.

6. The method of claim 1 wherein the sub-micron particles have a d₉₅ of about 1 1 microns or less, more preferably 0.8 microns or less and a d₅₀ is between 0.1 microns and 0.4 microns.

7. The method of claim 1 wherein the particles comprise basic copper carbonate.

8. The method of claim 1 wherein the particles comprise zinc borate.

9. The method of claim 1 wherein the particles comprise basic copper hydroxide.

10. The method of claim 1 wherein the aqueous suspension does not contain a substantial amount of ammonia or other volatile amines, and does not contain a substantial amount of organic solvent.

11. Treated fabrics or mats made by the process of claim 1.

12. Treated burlap made by the process of claim 1.

13. Treated fabrics or mats made by the process of claim 3.

14. Treated fabrics or mats made by the process of claim 4.

15. Treated fabrics or mats made by the process of claim 5.

16. Treated fabrics or mats made by the process of claim 6.

17. Treated fabrics or mats made by the process of claim 7.

18. Treated fabrics or mats made by the process of claim 8.

19. Treated fabrics or mats made by the process of claim 9.
